(19) United States
(12) Patent Application Publication
(10) Pub. No.: US 2011/0041288 A1
(43) Pub. Date: Feb. 24, 2011

(54) Adjustable hinge

(75) Inventor: Sergio Pacini, Montecarlo (Lucca) (IT)

Correspondence Address: POLLACK, P.C., THE CHRYSLER BUILDING, 132 EAST 43RD STREET, SUITE 760, NEW YORK, NY, 10017, US

(73) Assignee: Euroinvest S.p.A.

(21) Appl. No.: 12/586,244

(22) Filed: Sep. 19, 2009

(30) Foreign Application Priority Data
Sep. 19, 2008 (IT) FI2008A000180

(51) Int. Cl. E05D 7/04; E05D 11/06

(52) U.S. Cl. 16/244; 16/235; 16/242; 16/243

(57) ABSTRACT

An adjustable hinge comprising: a) two hinge bodies for attaching respectively to a window or door frame and a window or door leaf; b) a revolving pin suitable for mutually articulating the hinge bodies; c) a member for adjusting shared positions of the hinge bodies in a direction generally perpendicular to the axis of the pin. The adjustment member includes a sleeve, associated axially with the pin, defining an external lateral coupling surface with a corresponding housing defined in a first of the hinge bodies. The sleeve is pivotally engaged with the housing-such that, while remaining in relatively constant contact with the walls of the cavity during any rotation to change its position, it may occupy substantially any position required along a limited length of the perpendicular adjustment direction. A reversible locking member is also provided for locking the sleeve in positions it occupies inside the housing upon a thrusting action in a defined or selected locking direction. The sleeve has at least three distinct points of contact with the walls of the housing spaced angularly relative to one another. When the locking member is in action, at least two of the distinct points exert a thrusting force, in directions incident to one another, on respective points of the walls so as to accommodate for slack upon coupling between the sleeve and housing in directions generally incident to one another.

### FIELD OF THE INVENTION

The present invention relates generally to construction and, more particularly, to hinges for doors, windows or the like.

### BACKGROUND OF THE INVENTION

In the construction of buildings and homes, in general, it is often expedient, upon the addition of doors and windows, especially those that are relatively heavy or large in size, to use revolving hinges that allow for adjustment of the shared positions of the fixed frame and mobile frame (or leaf). Specifically, this adjustment compensates for any bending of the door or window assembly, and/or to enables proper operation, even in the case of orthogonal imperfections in the door or window relative to their respective horizontal plane.

The hinge generally allows for three possible adjustments: two adjustments of the mutual positions of the hinge bodies in two directions crosswise to the axis of the hinge pin (generally, one substantially “lateral” direction parallel to the plane of the door or window, and one direction orthogonal to said plane, these adjustments allowing the right pressure to be provided on the closure seal around the door or window), and one vertical adjustment of the mutual positions of the hinge bodies in the hinge axis direction.

The hinges of known type, as a rule, do not allow for any independent crosswise adjustments. At the most the mutual positions of the hinge bodies only can be adjusted simultaneously in both directions, which limits the actual range of the allowable adjustments.

An example of a type of adjustable hinge that attempts to overcome this drawback is described in the European patent EP 0 837 206, for instance. This document discloses a hinge consisting of an upper hinge body and a lower hinge body connected by a revolving pin. The upper hinge body is formed with a housing for inserting the revolving hinge pin. Inserted respect to the axis of the pin. This sleeve is narrower in dimensions than the housing in which it is inserted, but it is constantly in contact with the walls of the housing, whatever position it occupies therein. Moreover, the sleeve has a base block at the top with a toothed lateral surface that engages with position references on the walls of the housing. To make a crosswise adjustment of the position of the hinge bodies, it is necessary to raise the sleeve with the pin and rotate it by the required amount, corresponding to the translation that the user wishes to obtain due to the eccentricity between the sleeve and the pin, and then lower it again so that the toothed surface engages with the corresponding references on the housing. To lock the sleeve in position inside the housing, it is necessary to maintain a thrust that holds the base block against said references.

Clearly, such a hinge structure is complicated and it also does not allow for continuous crosswise adjustments, because the position of the sleeve, and consequently of the pin, is defined by the toothed surface.

Moreover, it should be emphasised that the recovery of any slack in the coupling between the sleeve and the housing is not particularly effective, being left to the thrust exerted on the base block that is not completely integral with the sleeve. Said slack needs to be avoided because it can lead to a faulty functioning of the door or window and the risk of breakages is increased.

Another solution for a hinge is illustrated, for instance, in the European patent EP 1 061 221. Said document discloses a hinge in which the upper hinge body includes a housing for a sleeve integral with the head of the pin revolving inside the hinge. This sleeve is off-centre with respect to the axis of the pin and, in practical terms, it constitutes a cam that is in contact with the walls of the housing at four points that are angularly spaced at 90° angles to one another, i.e. at the vertices of a cross. The sleeve—housing coupling is such that, once the sleeve is rotated (the pin cannot move because it is constrained to the translation of the lower hinge body), the housing displaces as a function of the eccentricity in the crosswise direction of adjustment. Once the adjustment has been made, the sleeve is pushed against the surface of the housing by means of a locking dowel. The thrusting action of the dowel coincides with the line passing through two points corresponding to opposite points of contact between the sleeve and the housing. This thrust enables the sleeve, and consequently also the pin, to be locked in position in relation to the upper body of the hinge, but it is unable to take up any slack in the coupling between the housing and the sleeve. In fact, the slack is taken up in one direction only, i.e. that of the thrust, and not in the direction orthogonal thereto, which effectively makes the recovery in only one direction pointless.

### OBJECTS AND SUMMARY OF THE INVENTION

Accordingly, it is an object of the present invention to provide an adjustable hinge for doors and windows that effectively compensates for slack upon coupling of the hinge components so as to avoid any malfunction or breakage.

Another important object of the present invention is to provide a hinge for doors and windows that is suitable for use even with heavy or large doors and windows, with progressive linear adjustments that are independent of one another and, more precisely, with a linear lateral adjustment (that consequently induces no perpendicular translations), a perpendicular adjustment to enable the right pressure to be exerted on the seal around the door or window, and a vertical adjustment to obtain the right distance from the floor.

At the same time, an object of the invention is to provide a hinge equipped with easily accessible adjustment means.

These and other objects, that will be better clarified below, are achieved by an adjustable hinge for doors and windows comprising:
two hinge bodies for fixing respectively to the fixed frame and to the mobile frame of the door or window,
a revolving pin for pivotally connecting said hinge bodies,
means for adjusting the mutual positions of said two hinge bodies in directions crosswise to the axis of said pin, said means of adjustment comprising a sleeve axially associated with said pin and defining an outer lateral surface for coupling with a corresponding housing defined in a first of said hinge bodies, said sleeve being pivotal inside said housing so that, while remaining constantly in contact with the walls of said housing during its rotation to change position, it can occupy substantially any position required along a limited length of said crosswise adjustment direction, means being provided for reversibly locking said sleeve in the positions it can occupy inside said housing by means of a thrust in a given locking direction,

characterised in that said sleeve comprises at least three distinct portions of contact with the walls of said housing angularly spaced from one another, and when said locking means are in action, at least two of said distinct portions exert a thrusting force—in directions incident to one another—on respective parts of said walls so as to take up any slack in the coupling between the sleeve and the housing in incident directions.

### BRIEF DESCRIPTION OF THE DRAWINGS

A specific, illustrative adjustable hinge, according to the present invention, is described below with reference to the accompanying drawings, in which:

FIG. 1 is a front view of a hinge, according to one aspect of the present invention;

FIG. 2 is a plan view of the hinge illustrated in FIG. 1;

FIG. 3 shows a door leaf fit with two hinges, according to one embodiment of the present invention;

FIG. 4 is an exploded axonometric view of a hinge, in accordance with the present invention;

FIG. 5 is a sectional plan view of the upper body of the hinge of FIG. 4;

FIG. 6 is an axial, front sectional view of the hinge illustrated in FIGS. 1-5;

FIG. 7 is a sectional plan view of the lower body of the hinge;

FIG. 8 is a sectional plan view of the upper body with the hinge adjusting sleeve in position “0”;

FIG. 9 is a sectional plan view of the upper body with the hinge adjusting sleeve in a position of maximum rightward extension;

FIG. 10 is a sectional plan view of the upper body with the hinge adjusting sleeve in a position of maximum leftward extension;

FIG. 11 shows schematic a plan view of the upper body with the hinge adjusting sleeve in various adjustment phases;

FIGS. 12, 13 and 14 are sectional plan views, indicating three different positions of inward or outward adjustment of the hinge; and

FIG. 15 is a variation of the hinge adjusting sleeve illustrated generally in FIGS. 1-14.

The same numerals are used throughout the drawing figures to designate similar elements. Still other objects and advantages of the present invention will become apparent from the following description of the preferred embodiments.

### DETAILED DESCRIPTION OF THE PREFERRED EMBODIMENTS

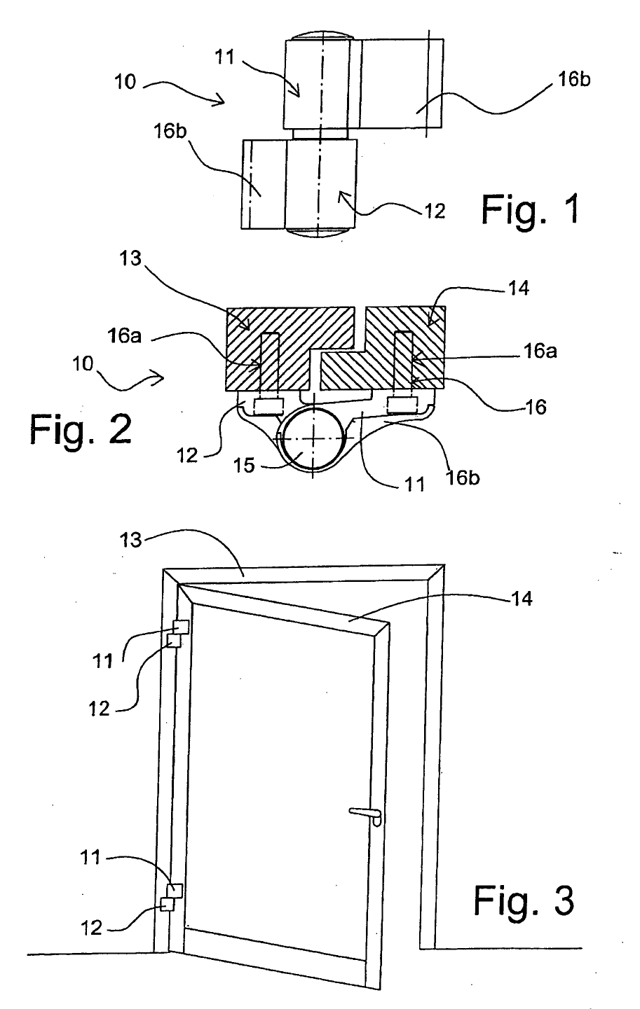

Referring now to the drawings and, more particularly, to FIGS. 1-15, there is shown generally a specific, illustrative adjustable hinge 10 for doors, windows or the like according to various aspects of the present invention. In one embodiment, illustrated generally in FIG. 1, the hinge comprises two hinge bodies, an upper body 11 and a lower body 12, respectively, for respective attachment to a fixed frame 13 and a mobile frame or leaf 14 of the door or window and pivotally connected to one another by a pin 15.

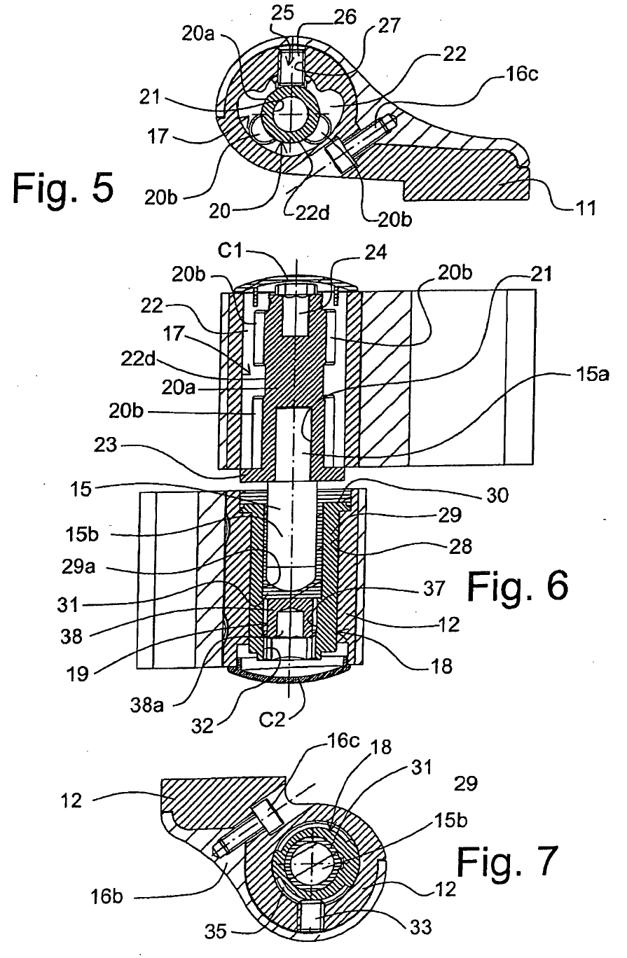

Both the upper body 11 and the lower body 12 of the hinge are provided with suitable means 16 for fixing them respectively to the leaf 14 and to the frame 13 of the door or window, such as fixing screws 16a and a plate 16b for covering the screws 16a. The plate 16b is attached with further screws 16c (see FIG. 5) accessible to the operator from the inner side of the door, and thereby also provides protection against burglars.

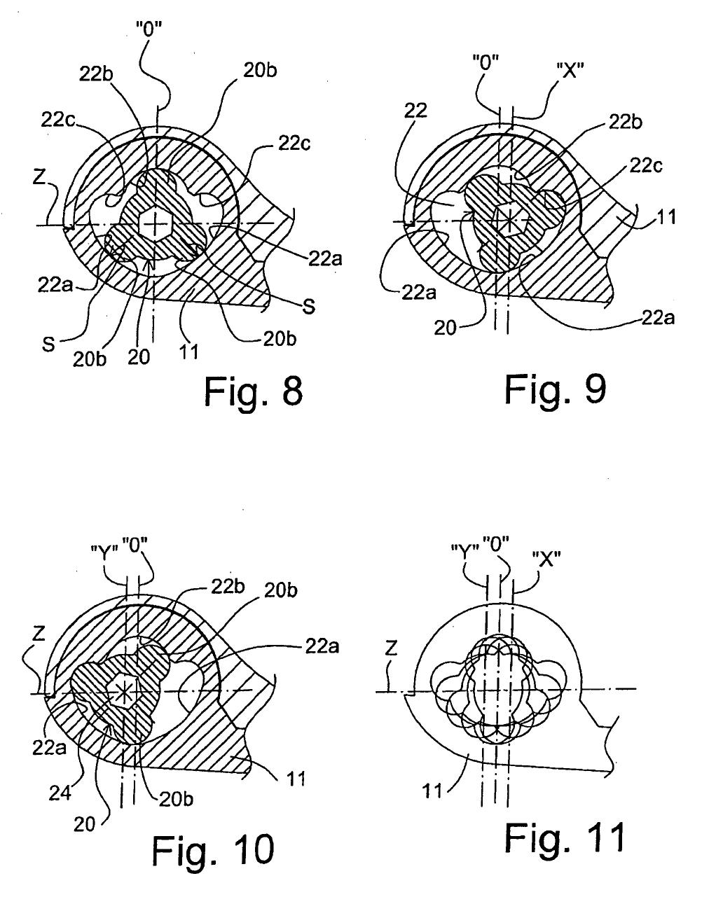

First means 17, described later on with reference in particular to FIGS. 5 and 6, for the adjustment of the mutual positions of the two hinge bodies in a direction crosswise to the axis of the pin 15 are associated with the upper body 11. More in particular, this direction is substantially parallel to the plane of the door or window leaf and is indicated by the letter Z in FIGS. 8, 9, 10 and 11. For the sake of brevity, from now on, the adjustment in said direction Z will be called “lateral adjustment”.

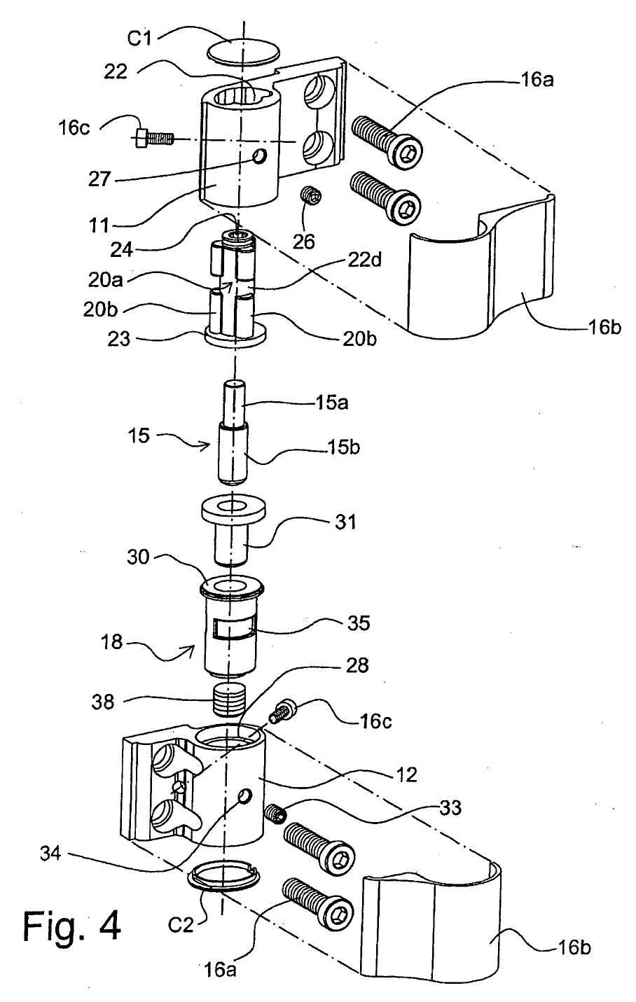

Second means 18 (see FIG. 4) for the adjustment of the mutual positions of said two hinge bodies 11 and 12 in a direction substantially orthogonal to the plane of the door or window leaf 14 (“orthogonal adjustment”) are associated with the lower body 12. Third means 19 for the adjustment of the mutual positions of said two hinge bodies 11 and 12 in the direction of the axis of the hinge pin (“vertical adjustment”) are also associated with the same lower body 12. The second and third adjustment means are described later on.

The first means 17 of hinge lateral adjustment comprise a sleeve 20 defining an internal seat 21 (or, in other words, a circular blind hole) for coaxially coupling, by interference, with the upper part 15a of the revolving pin 15, and an outer lateral surface for coupling with a corresponding housing 22 passing through the upper body 11. Clearly, in other embodiments, the pin 15 and sleeve 20 may be made in a single piece or, in any case, be monolithic.

The sleeve 20 substantially consists of a cylindrical body 20a extending over the full length of the upper body 11 of the hinge 10. A flange 23 abutting against the lower edge of the upper body 11 projects from the lower end of cylindrical body 20a. At the other end of the sleeve 20, opposite the flange 23, a blind hole 24 is formed, shaped to form a hexagon-shaped seat for a wrench.

The lateral surface of the cylindrical body 20a forming the sleeve 20 is formed with three distinct portions 20b of contact with the walls of the housing 22. In the present embodiment, the contact portions 20b are longitudinal projections with a semicylindrical shape the axis of which is parallel to the axis of the cylindrical body 20a. As clearly shown in the figures, the projections 20b are equidistant from one another around the cylindrical body 20a, i.e. they are spaced at an angle of 120°.

FIG. 15 shows a variation of the sleeve, identified here as 120, equivalent to the one described above. In this variation the sleeve 120 is still formed with three projections 120b, but two of them are radiused to one another.

The sleeve 20 is axially pivotable in the housing 22 and the form of the housing is such that, while the sleeve remains constantly in contact with the walls of the housing during its rotation to change position, it can occupy substantially any position along a limited length in the direction parallel to the plane of the door or window leaf, i.e. the direction Z of lateral adjustment of the first means 17. See specifically FIGS. 8, 9, 10 and 11.

In particular, the shape of the housing 22 is symmetrical with respect to a longitudinal plane parallel to the axis of the pin 15 and is formed with three different sliding grooves for respective projections 20b. In particular two first grooves 22a that are symmetrical to one another in relation to said plane, and one second groove 22b, extending between the first grooves 22a. The two first grooves 22a are radiused to one another at adjacent ends thereof, while at the opposite ends they have abutments 22c for the respective projections 20b, corresponding to the ends of the pivotal stroke of the sleeve 20, i.e. the limit stops for the adjustment in the direction of the plane of the door or window leaf 14.

The upper hinge body 11 comprises means 25 for reversibly locking the sleeve 20 inside the housing 22 by means of a thrust exerted in a defined locking direction that, in this example, is crosswise to the housing 22 (and also orthogonal to the lateral adjustment direction Z) and lies on its symmetry plane. In FIGS. 8, 9, 10 and 11, said plane/direction corresponds to the position “0” of the sleeve inside the housing, as explained in more detail later on.

The locking means 25 comprise, for instance (see FIGS. 4 and 5), a threaded dowel 26 inserted through a corresponding counter-threaded through hole 27 provided on the side of the upper hinge body 11. The dowel 26 extends in the housing 22 and abuts against the side of the cylindrical body 20a of the sleeve 20, at a recessed area or gap 22d formed an intermediate position in the projections 22a.

When the locking dowel 26 pushes against the cylindrical body 20a of the sleeve 20, at least two projections 20b exert a thrusting action on the inside wall of the housing 22, i.e. on the respective grooves 22a, 22b in two directions incident to one another. In other words, the thrust exerted by the dowel is decomposed along two directions that are not parallel to one another (in the example, the result is achieved because the projections are angularly spaced by 120°; in FIG. 8, the arrows showing the thrusting action on the projections for locking the sleeve are indicated by the letter S). The locking dowel thus succeeds completely in taking up any slack due to machining tolerances in the coupling between the sleeve 20 and the housing 22.

The lateral adjustment of the hinge is carried out as follows. The sleeve 20 is coaxial to the hinge pin 15 and it is integral therewith. The pin can rotate inside the lower hinge body 12. Action can be taken with a wrench in the hexagon-shaped seat in the blind hole 24 at the end of the sleeve 20 to make the sleeve rotate (note that the sleeve cannot translate because it is attached to the pin, which is pivotally connected to the hinge body associated with the fixed door frame). The particular shaping of the housing 22 ensures that the projections 20b sliding along the walls of the housing induce a thrust sufficient to achieve a substantial translation of the housing, i.e. of the upper hinge body 11, in the lateral adjustment direction Z (i.e. the direction parallel to the main plane of the door leaf).

FIG. 8 shows the respective positions of the sleeve 20 and the upper hinge body 11 in position “0”, i.e. in the position of intermediate adjustment in which the three projections 20a are in contact with their respective grooves on the inside walls of the housing 22 and the hinge body can still translate to the right or left of said position.

FIG. 9 shows the respective positions of the sleeve 20 and the upper hinge body 11 in position “X”, i.e. after maximal rightward displacement, where one projection 22a abuts against the corresponding limit stop 22c. Note that the axis of the pin 15 has been displaced from position “0” to position “X” while sliding in the Z direction; the three projections 22a are in a different position, but always abutting with the inside surface of the housing 22.

Similarly, FIG. 10 shows the respective positions of the sleeve 20 and the upper hinge body 11 in position “Y”, i.e. of maximal leftwards displacement, where one projection 22a abuts against the corresponding limit stop 22c. Note that the axis of the pin 15 has been displaced from position “0” to position “Y” while sliding in the Z direction; here again, the three projections are in another different position, but always abutting with the inside surface of the housing 22.

FIG. 11 schematically shows the mutual positions of the sleeve 20 and the upper hinge body 11 in any of the different intermediate positions in which they can be adjusted.

Once the upper hinge body 11 has been suitably positioned in relation to the sleeve 20, the locking dowel 26 is tightened against the sleeve 20, thus preventing any mutual movements of the sleeve and the housing and taking up the slack in the coupling between the two. Finally, a small cap C1 is fitted to cover the housing 22.

It should be noted that the respective positions of the sleeve and the housing can be adjusted continuously and not stepwise, so they can occupy any intermediate lateral hinge adjustment position.

As mentioned previously, second adjustment means 18 are advantageously associated with the lower body 12 for adjusting the respective positions of said hinge bodies 11 and 12 in a direction substantially orthogonal to the plane of the door leaf (“orthogonal adjustment”), and third adjustment means 19 are associated therewith for the vertical adjustment of the hinge. The first lateral adjustment means 17, the second orthogonal adjustment means 18 and the third vertical adjustment means 19 are substantially independent of one another.

As shown in particular in FIGS. 4, 6 and 7, the second orthogonal adjustment means 18 comprise a cylindrical cavity 28 passing through the lower hinge body 12 along an axis parallel to the axis of the pin 15. A sleeve 29 is housed in the cylindrical cavity 28 and is fitted with a flange 30 abutting against the upper end of the lower hinge body 12

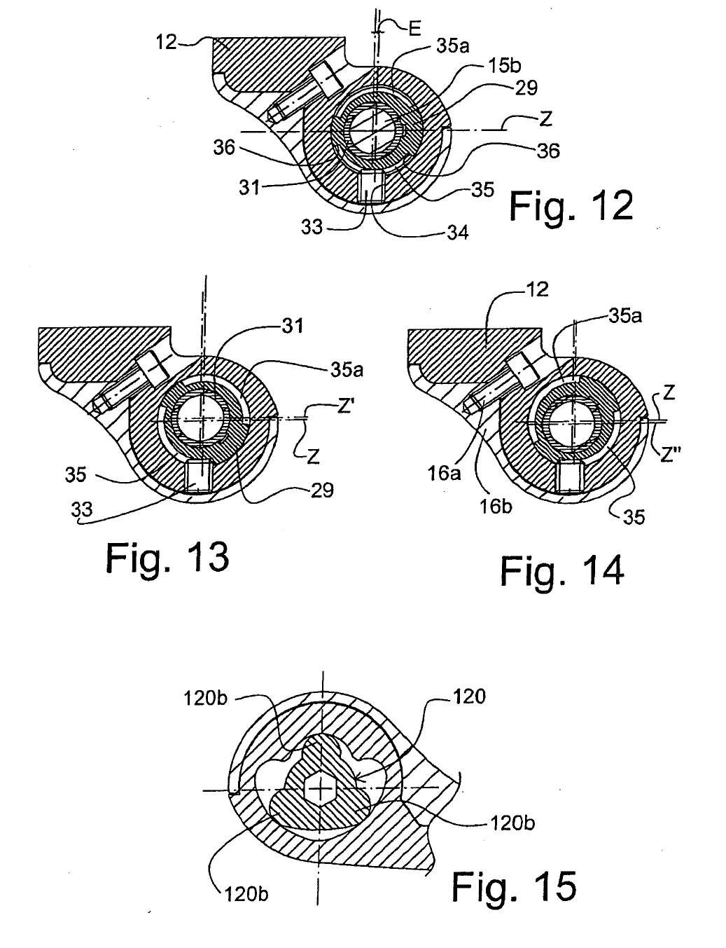

The sleeve 29 is formed with a vertically-extending through hole 29a, which in turn contains a bushing 31—made of a self-lubricating plastic material, for instance—pivotally housing the lower part 15b of the revolving pin 15. The bushing 31 is eccentric with respect to the sleeve 29. The eccentricity between the axis of the bushing 31 and pin 15 and the axis of the sleeve 29 is indicated by the letter E in FIG. 12. In this figure the axis of the bushing 31 and pin 15, and the axis of the sleeve 29 lie on the same plane, which coincides with the direction “Z”, i.e. a direction parallel to the plane of the corresponding door leaf (when closed) passing through the axis of the pin 15.

The lower opening 32 in the through hole 29a of the sleeve 29 is in the shape of a hexagon to enable the rotation of the sleeve with the aid of a suitable wrench. The bushing 31 on which the pin 15 is supported and rotates is substantially integral with the sleeve 29 so that, when action is taken on the hexagon-shaped lower opening 32, the bushing 31 is also rotated.

With reference to the orthogonal adjustment of the hinge, FIG. 12 shows the intermediate position of the hinge in which the eccentricity E is aligned with the direction Z. From the intermediate position, a rotation of the sleeve induces an angular displacement of the eccentricity and a consequent revolution of the axis of the pin 15 on a circular path with a radius E. Depending on the direction of rotation, the axis of the pin 15 may consequently come to be displaced forwards or backwards in a direction orthogonal to the direction Z, i.e. it may be brought closer to or further away from the door frame. FIG. 13 shows a clockwise rotation of the sleeve such that the pin 15 is displaced (in Z′) from the direction Z towards the door frame. FIG. 14 shows an anticlockwise rotation of the sleeve such that the pin 15 is displaced (in Z″) from the direction Z away from the door frame.

A screw 33 engages with the sleeve 29 through a counter-threaded through hole 34 in the side of the lower hinge body 12. One end of the screw 33 is inserted in a semicircular groove 35 formed on the lateral surface of the sleeve 29 and abuts against the sleeve 29 to lock it in position and take up any slack on the coupling between the cylindrical cavity 28 and the sleeve 29. The ends 36 of the groove 35 define the limits stops for the rotation of the sleeve and consequently the ends of stroke for the orthogonal adjustment of the hinge. There is a further semicircular groove 35a on the sleeve 29, symmetrical to the groove 35 in relation to a vertical plane, enabling the sleeve to be used for both rightward and leftward opening hinges.

The internal lower portion 37 of the through hole 29a in the sleeve 29 is threaded for coupling with a small counter-threaded cylinder 38, with a blind backing plate 38a that has a hexagonal shape to allow for the insertion of a suitable wrench. The bushing 31, and therefore the pin 15, rest on said small cylinder 38. Together, the small cylinder 38 and the internal lower portion 37 of the through hole 29a constitute the above-mentioned third adjustment means of vertical hinge adjustment 19. In fact, by acting on the small cylinder 38, the bushing 31 with the pin 15, and consequently also the upper hinge body 11, is displaced upwards or downwards.

Once the orthogonal and vertical adjustments are carried out, a lower cap C2 is inserted to cover the cylindrical cavity 28.

The hinge thus conceived enables the proposed objects of the invention to be achieved. In fact, this hinge structure enables the respective positions of the hinge bodies to be adjusted independently, thereby succeeding in completely taking up the slack due to manufacturing tolerances, entirely to the advantage of a greater durability of the hinge assembly.

In particular, this hinge enables a lateral adjustment of the respective positions of the hinge bodies that is extremely precise (because it is not stepwise) and that is particularly effective in taking up the slack, this latter action taking place “automatically” with the locking of the hinge bodies in the required position. Moreover, the range of adjustment is extremely precise thanks to the presence of limit stops on the adjustment elements, thereby any problems of erroneous hinge adjustments are avoided.

It has to be pointed out that the terms “upper” and “lower”, “right” and “left”, as used in the present specification, are to be understood with reference to the corresponding sides of the drawings in which the hinge of the invention is shown.

Clearly, the hinge thus conceived may undergo numerous modifications and variants, all coming within the scope of the present invention; moreover, all the components may be substituted with other, technically equivalent elements, without departing from the scope of the invention.

In practical terms, any materials may be used, providing they are compatible with the intended use, and they may be of any shape and size, according to need and the state of the art.

Where the characteristics and techniques mentioned in any of the claims are followed by reference signs, these have been included merely as an example and for the sole purpose of facilitating the reading of the claims and they shall consequently not be construed to limit the interpretation of the element they identify.

Various modifications and alterations to the present invention may be appreciated based on a review of this disclosure. These changes and additions are intended to be within the scope and spirit of this invention as defined by the following claims.

What is claimed is:

1. An adjustable hinge comprising:
a plurality of hinge bodies for attachment to a fixed frame and to a mobile frame, respectively, of a door or window,
a revolving pin for pivotally connecting the hinge bodies to one another,
a member for adjusting shared positions of the hinge bodies in a direction generally perpendicular to the axis of the pin, the adjustment member comprising a sleeve, associated axially with said the pin, defining an external lateral surface for coupling with a corresponding housing defined in a first of the hinge bodies, the sleeve being pivotal inside the housing such that, while it remains in relatively constant contact with the walls of the housing during its rotation to change position, it may occupy substantially any position required along a limited length of the perpendicular adjustment direction, a reversible locking member being provided for locking the sleeve in the positions it occupies inside the housing upon application of a thrusting force in a selected locking direction,
the sleeve has at least three distinct portions of contact with the walls of the housing, spaced angularly from one another, and when the locking member is in action at least two of the distinct contact points bring a thrusting force, in a directions incident to one another, on respective portions of the walls so as to accommodate for slack between the sleeve and the housing in incident directions.

2. The hinge to set forth in claim 1, wherein the sleeve comprises three distinct points of contact with the walls of the housing, spaced angularly relative to one another, the shape of the housing being symmetrical relative to a selected longitudinal plane generally parallel to the axis of the pin inside the sleeve, and having a plurality of sliding grooves for corresponding contact points, respectively, two first grooves symmetrical with one another relative to the plane, and one second intermediate groove between said the two first grooves, the two first grooves being radiused at adjacent ends, while having, at opposite ends, abutments for the respective contact points providing stops for rotation of the sleeve, the locking direction defined by the reversible locking of the sleeve lying in a plane of symmetry of the two first grooves.

3. The hinge set forth in claim 2, wherein the sleeve has a cylindrical body from which longitudinal projections extend laterally, defining the distinct portions of contact with the walls of the cavity, a flange at one end of the cylindrical body for abutting against the first hinge body at the opening of the housing, the projections having a substantially semicylindrical cross-section with an axis parallel to the axis of the cylindrical body, the projections further having a gap at an intermediate position that serves as a seat for a locking dowel of the reversible locking member, a seat being provided at one end of the cylindrical body for causing rotation of the sleeve with the aid of a wrench.

3. The hinge set forth in claim 1, wherein the first hinge body corresponds to the upper hinge body, the sleeve being mounted coaxially to the upper part of the pin, the perpendicular adjustment direction being substantially parallel to the plane of the mobile frame to which the hinge is attached with the aid of a mounting member.

4. The hinge set forth in claim 3, the first hinge body corresponds to the upper hinge body, the sleeve (20) being attached coaxially to the upper part of the pin, the perpendicular adjustment direction being substantially parallel to the plane of the mobile frame to which the hinge is attached with the aid of the mounting member.

5. The hinge set forth in claim 4, characterised in that it comprises a second member for adjusting the shared positions of the two hinge bodies 11 and 12 in a direction substantially orthogonal to the plane of the mobile frame to which the hinge is attached, the second member being independent of the parallel adjustment member.

6. The hinge set forth in claim 5, wherein the second adjustment member comprises a cylindrical cavity, passing through the lower hinge body, along an axis lying generally parallel to the axis of the pin, and inside the cylindrical cavity a sleeve is housed having a vertically extending through hole therein, which, in turn, contains a bushing that houses pivotally and concentrically the lower part of the revolving pin, the bushing housing the pin being mounted eccentrically relative to the sleeve, the lower opening of the through hole in the sleeve being shaped for coupling with a wrench suitable for inducing the rotation of the sleeve.

7. The hinge set forth in claim 6, wherein a screw inserted through a counter-threaded through hole formed in the side of the lower body engages the sleeve, and one end of the screw is inserted in a semicircular groove formed in the lateral surface of the sleeve so as to bear against the collar and, thereby, lock the latter in position and compensate for slack in the coupling between the cylindrical cavity and the sleeve, the ends of the groove defining the stops for rotation of the sleeve.

8. The hinge set forth in claim 7, wherein a further semicircular groove is formed in the sleeve, symmetrically located relative to the semicircular groove in relation to a vertical plane passing through the sleeve axis.

9. The hinge set forth in claim 1, further including a third member for vertical adjustment of the shared positions of the hinge bodies.

10. The hinge set forth in claim 9, wherein the third member for vertical hinge adjustment comprises a relatively small counter-threaded cylinder engaged with a threaded internal lower portion of the sleeve through hole, the bushing with the pin resting against the counter-threaded small cylinder.

11. The hinge set forth in claim 6, wherein the third member for vertical hinge adjustment comprises a relatively small counter-threaded cylinder engaged with a threaded internatl lower portion of the sleeve through hole, the bushing with the pin resting against the counter-threaded small cylinder.
